(19) United States
(12) Patent Application Publication
(10) Pub. No.: US 2014/0136502 A1
(43) Pub. Date: May 15, 2014

(54) File Lock Preservation

(71) Applicants: Nabeel M Mohamed, Vellore District (IN); Neducheralathan Shanmugam, Bangalore (IN)

(72) Inventors: Nabeel M Mohamed, Vellore District (IN); Neducheralathan Shanmugam, Bangalore (IN)

(73) Assignee: Hewlett-Packard Development Company, L.P., Houston, TX (US)

(21) Appl. No.: 14/232,002

(22) PCT Filed: Apr. 19, 2012
(86) PCT No.: PCT/US2012/034284

§ 371 Date: Jan. 10, 2014

(30) Foreign Application Priority Data
Oct. 31, 2011 (IN) 3106/DEL/2011

(51) Int. Cl. G06F 17/30

(52) U.S. Cl. CPC G06F 17/30362
USPC 707/704

(57) ABSTRACT

A method for preserving file locks is described herein. The method includes detecting a node migration event, occurring at a migrating node, in a cluster system (105) and in response to detection of the node migration event, initiating a deny mode for an affected node in the cluster system (105), the deny mode being initiated with respect to an affected file system. Further, it is ascertained whether a migration completion criterion is met and an allow mode for an adoptive node is initiated, when the migration completion criterion is met. In the allow mode, the adoptive node processes lock reclaim requests associated with a migrating node.

### CROSS-REFERENCE TO RELATED APPLICATION

The present application is a 371 application of International Application No. PCT/CN2012/034284 filed on Apr. 19, 2012 and entitled “File Lock Preservation,” which claims benefit of Indian Patent App. No. 3106/DEL/2011 filed on Oct. 31, 2011.

### BACKGROUND

With the recent advances in technology, a common storage resource may be accessed by multiple clients through a cluster file system (CFS) architecture. In the CFS architecture, a cluster having multiple nodes, also referred to as cluster servers or node servers, appears to be a single server to the clients. The cluster provides access to the common storage resource such that the common storage resource may be accessed by a client through one of the nodes of the cluster. The nodes serve as intermediary entities between a client and the common storage resource.

Further, to provide access to the clients to the common storage, various distributed file system (DFS) protocols may be used. The DFS protocols allow a client to mount a volume of common storage resource and then access files in the mounted volume as though those files were local to the client. In some cases, various clients may contend for the same file. To ensure that a file being assessed by a client may not be modified by another client, file locking services may be provided by the DFS protocols. The file locking service allows a single client a secure access to a file at any specific time.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 illustrates a cluster file system environment, in accordance with an embodiment of the present invention.

FIG. 2 illustrates components of a cluster system, in accordance with an embodiment of the present invention.

FIG. 3 illustrates a method to preserve file locks in a cluster file system environment, in accordance with an embodiment of the present invention.

FIG. 4 illustrates a method for preserving file locks in a cluster file system environment, in accordance with an embodiment of the present invention.

### DETAILED DESCRIPTION

Devices and methods for preserving file locks in a cluster file system (CFS) environment are described. These devices and methods can be implemented in a diversity of computing systems, such as a server, a desktop, a personal computer, a notebook, a portable computer, a workstation, a mainframe computer, a mobile computing device, and an entertainment device.

Generally, to scale up the access to resources, such as storage resources, that are common to multiple clients, distributed file system (DFS) protocols are implemented over an CFS architecture. The CFS architecture implementing the DFS protocol includes one or more nodes through which the clients may access a storage resource. The nodes may manage individual client requests for data at a file level. For example, a client may request a node to provide an access to a file. Further, an application running on the client may request the node to ascertain whether the file is locked for access or not. A file may be said to be locked in cases where it is currently being used by another client and may not be accessed. In case the file is locked by another client, the node may request the client contending for the file to wait until the lock is released. Such a request may be referred to as a blocking file lock request. A blocking file lock request may be understood as a request which is waiting to grab a lock, which is currently being acquired by some other client. Further, if the file is not locked, the client may be granted access to this file and it may be understood that this client has then acquired the lock for the file.

The locking of the file provides for data coherency by ensuring that while a client accesses a file, no other client may modify this file. Thus, a client may want to hold the lock to a file till the client is done with accessing the file. In certain events, such as a client failure event, and a node migration event, a client may lose lock to a file. A client failure event may said to have occurred when a client crashes or is rendered non-operational for a finite time period. A node migration event may be understood as an event in which services of a node may have to be migrated to another node in the cluster. The node migration event may occur in various circumstances, such as upon failure of a node or for balancing load on a node.

In an event of node migration occurring at a node, in addition to services, locks to various files made available to clients through the node may also be migrated to any other node of the cluster. For the purpose of explanation, a node whose services are to be migrated may be referred to as a migrating node, and a node to which services are migrated is referred to as an adoptive node.

In certain cases before a lock is migrated to the adoptive node, a lock held by a client may be inadvertently released at the migrating node. In such a situation, another client, who had a blocking file lock request with respect to the locked file, may grab the lock for this file, which in turn may lead to lock coherency issues. For example, consider a cluster having three nodes, namely, node 1, node 2, and node 3. Further, node 1 may crash and accordingly services provided by node 1 may be migrated to another node, say, node 2. There may be a case when node 1 crashes, a lock for a file held by a client of node 1 may be released and at the same time a blocking file lock request at another node, say, node 3 may grab the lock, which was previously held by the client of node 1. Generally post-migration, clients are unaware that they are being served by another node, therefore the client may attempt to access the file by perceiving its lock reclaim request as a valid file lock request. A lock reclaim request may be understood to be a file lock request to reclaim a lock that was held by a client, which was served by the migrating node before the node migration event. Further, post migration, there may be a case where the lock is made available to a blocking file lock request. In such cases, the adoptive node may reject the lock reclaim request as an invalid request, which in turn may lead to lock coherency issues.

In order to preserve file locks during node migration, various techniques are implemented. In one such technique one or more file systems that are exported by the migrating node are allowed to be exported by a single adoptive node in a cluster. For the purpose of explanation, file systems exported by the migrating node may be referred to as affected file systems, while others may be referred to unaffected file systems. In the technique described above, restriction of granting access to the affected file systems through the single adoptive node may be considered to be similar to a non-CFS environment. In other words, the scalability and performance of the CFS may be affected.

In some other techniques, to preserve file locks, lock related transactions performed by nodes of a cluster are put to a halt for affected as well as unaffected files systems. Thus, in addition to the affected file systems, lock related transactions are blocked for the unaffected file systems as well. Further, generally, in such techniques, the node migration event, such as a node failure, is detected by a node, which may result in a timing window, where a lock can be lost before the node detects the node migration event.

Alternately, in some other techniques, a CFS may be provided with additional protocols to facilitate lock preservation. However, implementation of additional protocols may unnecessarily overload the CFS with lock preservation functionality, which is usually implemented at the NFS level. Additionally, since the lock preservation functionality may be specific for a CFS, therefore such lock preservation functionality may not be extended to other CFS implementations.

According to an embodiment, the present subject matter provides for preservation of locks in a CFS environment. In an implementation, in response to detection of a node migration event caused by, say, a node failure, nodes of the cluster, excluding the migrating node, exporting one or more affected file systems are put in a deny mode. Further, for such nodes access to the affected file systems may be disabled. The nodes that export the affected file systems may be referred to as the affected nodes. In the deny mode, an affected node may not perform file locking transactions with respect to one or more affected file systems. Further, for the affected nodes, access to the affected file systems may be disabled.

In an implementation, upon occurrence of the node migration event, a node migration process for a migrating node may be initiated. During the node migration process, services performed by the migrating node may be migrated to one or more other nodes, also referred to as the adoptive nodes. In an example, affected nodes may be kept in the deny mode, with respect to the affected file systems, till a migration completion criterion is met. Since, the affected nodes may not process file locking requests during the node migration process, the blocking file lock requests may not be granted locks for already locked files, thereby ensuring that the clients of the migrating node may not lose the lock while the services are being migrated to the adoptive nodes.

Further, when the migration completion criterion is met, the adoptive nodes may enter an allow mode with respect to the affected file systems. In the allow mode, an adoptive node may process lock reclaim requests associated with the migrating node but may not process normal lock requests. A normal lock request may be understood to be a file lock request, received and processed using a normal lock processing logic, which may be defined by an underlying file locking feature of the DFS protocol.

In an example, the adoptive nodes are kept in the allow mode for a lock reclaim duration. Accordingly, for the adoptive nodes, access to the affected file systems may be enabled until the expiry of the lock reclaim duration. In the lock reclaim duration, the clients, served by the migrating node, may reclaim their corresponding locks. Thus, the clients get an opportunity to acquire the locks which were held by them prior to the node migration event, thereby minimizing the chances of these locks being grabbed by other clients, who may be having blocking file lock requests.

In one implementation, on lapse of this lock reclaim duration, the affected nodes may be put in a normal mode. In the normal mode, the file lock requests are processed using the normal lock processing logic. Thus, upon expiration of the lock reclaim request, the adoptive nodes may enter from the allow mode to the normal mode, and other affected nodes, which were previously in the deny mode, may also be put in the normal mode.

The present invention provides for preservation of locks in various scenarios, such as a single node crash, a multiple node crash, and manual migration of services, thereby avoiding lock coherency issues. Further, since, migration of services, and preservation of the file locks may be handled by the NFS layer in the nodes, minimal changes may be required in the underlying CFS layer, and the present invention may be extended to various CFS implementations.

While aspects of described systems and methods for preservation of file locks in a cluster file system environment can be implemented in any number of different computing devices, environments, and/or configurations, the implementations are described in the context of the following device architecture(s).

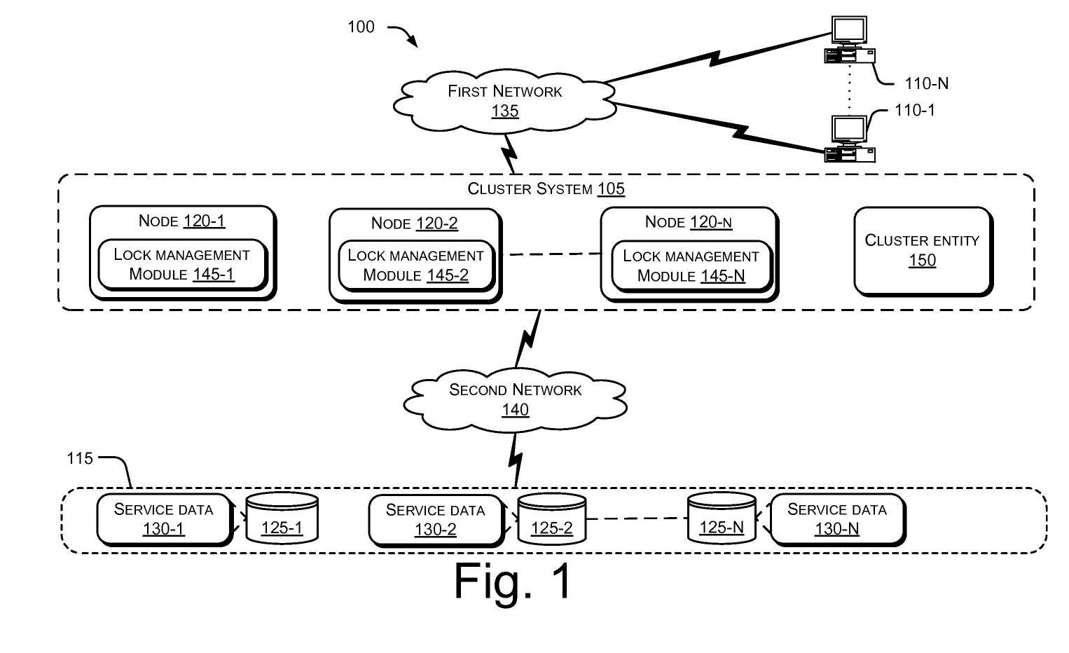

FIG. 1 illustrates a cluster file system (CFS) environment 100 implementing a cluster system 105 for preserving file locks, in accordance with an embodiment of the present invention. The CFS environment 100 includes a plurality of client devices 110, such as client device 110-1, and client device 110-N, accessing a storage resource 115 through the cluster system 105. For the sake of clarity a single storage resource 115 and a single cluster system 105 are illustrated; however it will be understood that the CFS environment 100 may include multiple cluster systems and multiple storage resources as well. The cluster system 105 includes a plurality of nodes 120, such as node 120-1, node 120-2, and node 120-N, to provide access to the storage resource 115.

The storage resource 115 may include the storage resource 115 may include one or more physical storage devices for storing data as files. The storage resource 115 may include, for example, hard disks, tapes, a cache, an array of disks, such as Just a Bunch of Disks (JBOD), and a redundant array of independent disk (RAID). A file can be considered a logical unit obtained after abstracting physical locations of data stored in one or more physical storage devices. These files can be organized and stored using one or more cluster file systems 125, such as file system 125-1, file system 125-2, . . . and file system 125-N. In an example, the file systems 125 may belong to same CFS technology and each of the file systems 125 may have their own name space. Further, each of the file systems 125 may include service data 130. For example, the file system 125-1 may include service data 130-1, the file system 125-2 may include service data 130-2, and the file system 125-N may include service data 130-N.

The client devices 110 may communicate with the cluster system 105 to access the storage resource 115 over a first network 135. The first network 135 may be wireless or wired network, or a combination thereof. The first network 135 can be a combination of individual networks, interconnected with each other and functioning as a single large network, for example, the Internet or an intranet. The first network 135 may be any public or private network, including a local area network (LAN), a wide area network (WAN), the Internet, an intranet, a mobile communication network and a virtual private network (VPN).

The client devices 110 and the nodes 120 may be implemented as any computing device, such as a laptop computer, a server, a desktop computer, a notebook, a mobile phone, a personal digital assistant, a workstation, and a mainframe computer. Alternately, multiple clients may be implemented as separate processes executing in the same computing device. Further, each of the client devices 110 may include machine readable instructions for communicating with any of the nodes 120 to access the storage resource 115. The client devices 110 may issue requests to the nodes 120 to access the storage device 115.

In an example, to access the storage resource 115, the nodes 120 may communicate with the storage resource 115 through a second network 140. Similar to the first network 135, the second network 140 can be a combination of individual networks, interconnected with each other and functioning as a single large network, for example, the Internet or an intranet. Examples of such networks include, but are not limited to, Storage Area Networks (SANs), LANs, WANs and Metropolitan Area Networks (MANs).

Further, to provide access to the storage resource 115, the nodes 120 may implement a distributed file system (DFS) protocol, such as network file system (NFS), Windows™ DFS, and Cisco™ DFS. Additionally, the DFS protocol may also provide file locking services. Further, the nodes 120 may run different or same services, where each service can be considered as being performed by a virtual node serving its own set of client devices 110. Further, each service is associated with one or more unique internet protocol (IP) addresses and one or more file systems 125 exported by the service to enable the client devices 110 to access the storage resource 115.

In one implementation, among other things, each of the nodes 120 may include a lock management module 145 to provide file locking services. For example, a client device 110, say, the client device 110-1 sends a request to a node, say, node 120-1, to access a file. Upon receiving such a request, the lock management module 145 may determine if the requested file is locked. Based on the determination, the lock management module 145 may allow the client device 110-1 to access the file or may request the client device 110-1 to wait. Similarly, various other nodes 120 through their respective lock management modules 145 allow for locking of the files.

While the various client devices 110 are accessing the storage resource 115, a node migration event may occur. The node migration event may occur, for example, when a node crashes or to balance load on one of the nodes 120. In an example, a cluster entity 150 of the cluster system 105 may detect a node migration event and upon the detection the cluster entity 150 may determine affected file systems. The cluster entity 150 may store file locks and may remove or add file locks based on instructions received from the lock management modules 145. Although cluster entity 150 has been illustrated as a separate entity, it will be understood that the functionality of the cluster entity 150 may be provided on any of the nodes 120 as well. The affected file systems are the file systems 125 that are exported by a migrating node, i.e., a node whose services are to be migrated. Further, one or more nodes 120 to which the services are migrated may be referred to as adoptive nodes.

In an implementation, the cluster entity 150 may also determine the nodes 120 that export the affected file systems. The nodes 120 exporting the affected file systems may be referred to as the affected nodes. In response to detection of a node migration event, the affected nodes may be notified to enter into a deny mode with respect to the affected file systems and access to the affected file systems may be disabled. Thus, in a deny mode access to the affected file systems may be disabled and an affected node may not perform file locking transactions relating to the affected file systems. Further, a migration process or a reconfiguration process may be triggered, upon detection of the node migration event. In an example, the services running on the migrating node may be migrated based on a configuration file provided in the migrating node. The configuration file may contain names of the adoptive nodes and the names may be arranged in the order of migration preference. Accordingly, services of the migrating node may be transferred to the adoptive nodes.

Further, it will be understood that the nodes 120, which do no export the affected file systems may not enter the deny mode and may perform the normal file locking transactions. Furthermore, in case a node 120 exports affected as well unaffected file systems, such a node 120 may enter the deny mode with respect to the affected file systems and may remain in a normal mode with respect to the unaffected file systems. A normal mode may be understood as a mode in which a node performs file locking transactions as usual.

In an implementation, the adoptive nodes may continue to be in the deny mode till a migration completion criterion is met. In an example, the migration completion criterion may be that number of services pending for migration are greater than a predetermined number, for example, zero. Additionally or alternately, another migration completion criterion can be expiration of a predetermined duration. The predetermined duration granted for migration may be referred to as migration duration.

Accordingly, the adoptive nodes may switch to an allow mode when the migration completion criterion is met, while other affected nodes may continue to remain in the deny mode. In the allow mode, the adoptive nodes may process lock reclaim requests and may not take up new file lock requests. In an example, to process the lock reclaim requests from various client devices 110, the access to the affected file systems may be enabled. Further, the lock management modules 145 of the adoptive nodes may also notify the client devices 110 served by the migrating node to reclaim locks to files that were being accessed by them prior to the node migration event.

Further, the client devices 110 may be provided with a predefined time duration to reclaim the locks. In other words, the adoptive nodes may remain in the allow mode for the predefined time duration. The predefined time duration provided for reclaiming the locks may be referred to as lock reclaim duration. Thus, in the lock reclaim duration other affected nodes may continue to be in the deny mode and the adoptive nodes may process the lock reclaim requests, thereby ensuring the client devices 110 associated with the migrating node get an opportunity to grab the locks previously held by them and blocking file lock requests by other client devices 110 may not grab the lock to the same files.

In an implementation, upon expiration of the lock reclaim duration, the affected nodes including the adoptive nodes may enter the normal mode and the access to the affected file systems may be enabled. Thus, before the affected nodes enter the normal modes, the client devices 110 associated with the migrating node may have reclaimed the lock thereby avoiding lock coherency issues.

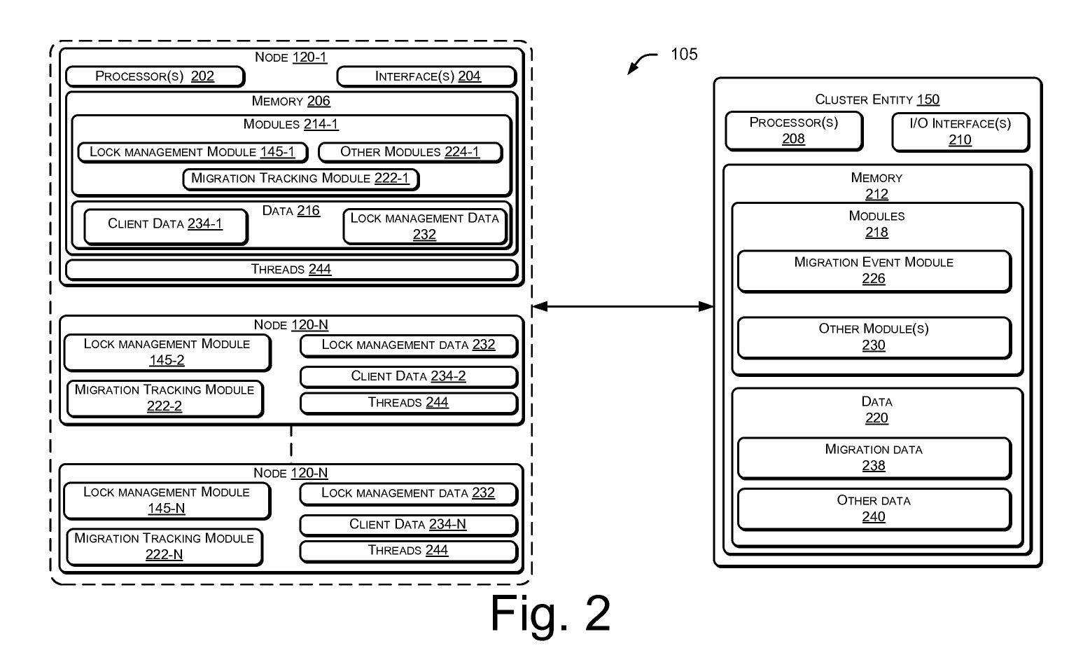

FIG. 2 illustrates various components of the cluster system 105, according to an embodiment of the present subject matter. The cluster system 105, among other things, includes the nodes 120 and the cluster entity 150. The nodes 120 include a processor 202, an interface 204, and a memory 206. For example, the node 120-1 may include a processor 202-1, an interface 204-1, and a memory 206-1 the node 120-2 may include a processor 202-2, an interface 204-2, and a memory 206-1, and so on. Likewise, the cluster entity 150 may include a processor 208, an interface 210, and a memory 212. The processors 202 and 208 may include microprocessors, microcomputers, microcontrollers, digital signal processors, central processing units, state machines, logic circuitries and/or any devices that manipulate signals and data based on operational instructions. Among other capabilities, the processors 202 and 208 may fetch and execute computer-readable instructions stored in the memory 206 and 212 respectively.

The interfaces 204 and 210 may include a variety of software and hardware interfaces, for example, interface for peripheral device(s), such as data input/output devices, storage devices, and network devices. The interfaces 204 and 210 may include Universal Serial Bus (USB) ports, Ethernet ports, Host Bus Adaptors and their corresponding device drivers. The interfaces 204 and 210, amongst other things, facilitate receipt of information by the nodes 120 and the cluster entity 150 from other devices, such as the client devices 110.

The memory 206 and 212, may include any computer program product. The computer program product may include any computer-readable medium including, for example, volatile memory, such as static random access memory (RAM), dynamic RAMs, and non-volatile memory, such as read only memory (ROM), erasable programmable ROM, flash memories, hard disks, optical disks, and magnetic tapes. The memory 206 of the nodes 120 may include module(s) 214-1 and data 216. Likewise, the memory 212 of the cluster entity 150 may include module(s) 218 and data 220. The modules 214 and 218 may include routines, programs, codes, objects, components, and data structures, which perform particular tasks or implement particular abstract data types. The modules 214 may include the lock management module 145, a migration tracking module 222, and other modules 224. For example, the modules 214 of the node 120-1 may include the lock management module 145-1, a migration tracking module 222-1, and the other modules 224-1. The module 218 may include a migration event module 226 and other modules 230. The other modules 224 and 230 may include modules, such as an operating system, and modules for supporting various functionalities of the nodes 120 and the cluster entity 150 respectively.

The data 216 and 220 serve as repositories for storing information associated with the modules 214 and 218 respectively and any other information. The data 216 includes lock management data 232, client data 234, and other data (not shown in the figures). For example, the data 216 of the node 120-1 may include client data 234-1 and similarly data in the node 120-2 may include client data 234-2 and so on. Further, the data 220 of the cluster entity 150 may include migration data 238 and other data 240. The nodes 120 may also include threads 244, which include threads performing various tasks. The threads 244 may include migration detection threads, migration tracker threads, and timer threads.

In an implementation, each of the nodes 120 may provide one or more services to client devices 110. Further, each service may export a corresponding file system 125 from the storage resource 115. In an example, for each exported file system, each of the nodes 120 may have a migration detection thread, which may sleep at an interface, such as an input/output control (ioctl) interface provided at the cluster entity 150. For example, the node 120-2 may export the file system 125-1 and the file system 125-2. In said example, the node 120-1 may include two migration detection threads, one for the file system 125-1 and other for the file system 125-2.

The cluster entity 150 may wake up one or more migration detection threads, upon detection of the node migration event. In one implementation, the migration event module 226 may detect the occurrence the node migration event. For example, the migration event module 226 may determine that the node 120-1 has crashed and may be identified as the migrating node 120-1. In another example, it may be determined that the node 120-1 is overloaded and the services of the node 120-1 may be migrated for load balancing purposes.

For the purpose of explanation and not as a limitation, foregoing description is with reference to the node 120-1 as the migrating node, the node 120-2 and the node 120-N as one the affected nodes, and the node 120-2 as the adoptive node. For example, if the migrating node 120-1 exports the file systems 125-1 and 125-2; the file system 125-1 and 125-2 may be identified as the affected file systems. In said example, it may be determined that the node 120-2 exports file systems 125-1 and 125-2; and the node 120-N exports file systems 125-2, and 125-N. Accordingly, the nodes 120-2 and 120-N may be identified as the affected nodes.

In an implementation, upon detection of the node migration event, the migration event module 226 may obtain node migration information pertaining to such event from the service data 130 corresponding to the exported file systems 125. The node migration information may include IDs of the affected nodes 120-2 and 120-N that have exported the affected file systems, and number and names of the services exported by the migrating node. The obtained information may be stored in the migration data 238, from where all the nodes 120 may be able to access the same. Although the migration data 238 has been illustrated internal to the cluster entity 150, it will be understood that the migration data 238 may be located external to the cluster entity 150 as well. The migration data 238 may include a database file including the node migration information.

Further, upon detection of the node migration event, the migration event module 226 may provide node migration notifications to the affected nodes 120-2 and 120-N. The node migration notifications may also include node ID of the migrating node 125-1. In an implementation, the migration detection threads for the file systems 125 exported by the nodes 120 may sleep at the cluster entity 150 and upon detection of the node migration event, the migration event module 226 may invoke the migration detection threads for the affected file systems exported by the affected nodes 120-2 and 120-N. Referring to the example mentioned above, the migration event module 226 may wake up migration threads corresponding to the file systems 125-1 and 125-2 for the affected node 120-2. Further, for the affected node 120-N, the migration event module 226 may wake up migration threads corresponding to the file systems 125-2.

The invoked migration detection threads may notify respective lock management modules 145 of the affected nodes 120-2 and 120-N that a node migration event has occurred with respect to the affected file systems 125-1 and 125-2. Upon receiving the node migration notifications, the lock management module 145-2 and 145-N may initiate the deny mode with respect to the affected file systems 125-1 and 125-2. In another implementation, the cluster entity 150 may initiate the deny mode for the affected nodes 120-2 and 120-N upon detection of a node migration event. Thus, the affected node 120-2 may not process file locking requests relating to the affected file systems 125-1 and 125-2. Similarly, the affected node 120-N may not process file locking requests relating to the affected file systems 125-2, while the affected node 120-N may continue to process the file locking request for the file system 125-N. Accordingly, for the unaffected file systems, such as the file system 125-N, the nodes 120 may continue to process the file locking request as in a normal mode. Thus, locks held by the client devices 110, which were served by the migrating node 120-1, may not be grabbed by waiting blocking file lock request at the affected nodes 120-2 and 120-N.

In an implementation, upon receiving the node migration notification, the lock management modules 145-2 and 145-N may trigger respective migration tracking modules 222-2 and 222-N to track a migration process. In order to determine, if the migration process is complete, the migration tracking module 222-2 and 222-N may determine whether a migration completion criterion is met. For example, the migration tracking modules 222-2 and 222-N may monitor migration data 238 to check whether a migration completion criterion is met.

The migration tracking modules 222-2 and 222-N may track whether the number of migrated services pending for migration is greater than or a predetermined number. In an example, once a service is successfully migrated, information pertaining to a node 120 to which the service has been migrated may be updated in the service data 130 and may be removed from the migration data 238. Accordingly the tracker threads may observe a reduction in the number of services pending for migration by 1. The migration tracking modules 222-2 and 222-N may track the number of migrated services by way of respective tracker threads. The tracker threads track the migration data 238 to check whether the services of the migrating node 120-1 have been successfully migrated to one or more adoptive nodes. The tracker threads may monitor the migration data 238 periodically.

Further, the migration tracking modules 222-2 and 222-N may also monitor migration duration, to ascertain if maximum time period granted for the migration process has expired. The migration duration may be stored in the lock management data 232. In an example, the duration of the migration duration may be dynamically set based on number services that are to be migrated. Thus, a maximum period for which the migration process may continue may be provided by the migration duration. In one implementation, the maximum period for the migration process may allow the migration to be accomplished in a predefined finite time since there may be few services that are not configured to be migrated. Thus, in such cases, expiration of the migration duration may be ascertained before the other condition, which is number services being less than equal to a threshold, thereby indicating completion of migration process.

In an implementation, when the migration completion criterion is met, the migration tracking modules 222-2 and 222-N may also determine whether corresponding affective nodes 120-2 and 120-N are adoptive nodes. For example, the migration data 238 may indicate that the services of the migrating node 120-1 have been migrated to the affected node 120-2 and accordingly the migration tracking module 222-2 may ascertain that the affected node 120-2 is an adoptive node based on the migration data 238. Similarly, the migration tracking module 222-N may ascertain that none of the services running on the migrating node 120-1 have been transferred to the affected node 222-N, accordingly the migration tracking module 222-N may ascertain that the affected node 222-N is not an adoptive node.

Based on the ascertainment, the lock management module 145-2 of the affected node 120-2, now the adoptive node 120-2, may initiate the allow mode for the adoptive node 120-2, and the lock management module 145-N may continue to keep the affected node 120-N in the deny mode. In an example, the lock management module 145-2 may enable access to the affected file systems 125-1 and 125-2 for the affected node 120-2; and the lock management module 145-N may not enable access to the affected files systems 125-1 and 125-2 for the affected node 120-N.

During the allow mode, the lock management module 145-2 may process the lock reclaim requests. In an example, the lock management module 145-2 may gather information regarding client devices 110 that held a lock before the node migration event. Such client devices 110 may be provided with a lock reclaim notification, where the client devices 110 can reclaim their file locks. Thus, the client devices 110 that acquired the locks prior to the node migration event get an opportunity to reclaim these file locks, since the other adoptive nodes, such as the adoptive node 120-N are in the deny mode, where file lock requests may not be processed. The allow mode may be for a predetermined time duration, also referred to as the lock reclaim duration.

In an example, the adoptive node 120-2 may already have a blocking file lock request for a file that was locked by the migrating node 120-1. In such cases, before the client devices 110 of the migrating node 120-1 can reclaim the lock, it may so happen that another client device 110 having the blocking file lock request at the adoptive node 120-2 may grab the lock. In order to avoid such lock coherency issues, the lock management module 145-2 may determine whether a file lock request is a blocking file lock request or a reclaim request. If it is determined that the lock in the allow mode is grabbed by a blocking lock request, the lock management module 145-2 instead of sending a lock grant notification, may unlock this lock and make a thread corresponding to the blocking file lock request to wait. In an example, the lock management module 145-2 may look up in the client data 234-2, which includes information, such as client addresses, status of each client, which file is locked by which client, virtual interface address, to determine whether a request is blocking lock request or a reclaim request. Further, the details pertaining to list of files locked by various clients may also be stored in the cluster entity 150. Furthermore, after the expiration of the lock reclaim duration, this waiting thread may be woken up to try acquiring the lock again. Also, the reclaim requests may be made to retry till the lock reclaim duration is over.

In case there are multiple adoptive nodes, allow modes for the adoptive nodes may be initiated concurrently. The lock reclaim duration for all the adoptive nodes may be same, i.e., the migrated services get an equal time slice for reclaiming the locks, thereby providing for enhanced continuity of the input/output operations performed by the nodes 120.

In an example, the lock management modules 145-2 and 145-N of the affected nodes 120-2 and 120-N may determine if the lock reclaim duration has expired. The lock reclaim duration may be stored in the lock management data 232. The lock management module 145-2 and 145-N may determine the same by way of respective timer threads. Upon determining that the lock reclaim duration has expired, the lock management module 145-2 and 145-N may initiate the normal mode for the affected node 120-2 and 120-N. Thus, after the lapse of the lock reclaim duration, the adoptive node 120-2 is moved from the allow mode to the normal mode and the affected node 120-N is moved from the deny mode to the normal mode. Accordingly, access to the affected file systems 125-1 and 125-2 for the affected nodes 120-2 and 120-N may be enabled.

Further, in cases of manual migration, when services running on the migrating node 120-2 are being migrated, the affected nodes 120-2 and 120-N are put in the deny mode. In such a case, the lock management module 145-1, may notify the migration event module 226 that it is to be migrated. Further, the lock management modules 145-2 and 145-N may freeze access to the affected file systems 125-1 and 125-2 for the respective affected nodes 120-2 and 120-N.

In order to facilitate migration of services performed by the migrating node 120-1, locks held by the services running on the migrating node 120-1 may be released. In an example, a single service is migrated at a time to preserve locks held by the migrating service. The lock management module 145-1 may initiate the allow mode for the migrating node 120-1 with respect to this migrating service and the deny mode with respect to other services, i.e., the services running on the migrating node 120-1 other than the one, which is being migrated. This may be done to ensure that no other service on the migrating node 120-N may grab the lock while the first service is being migrated, for example, in case multi node crash scenario.

Although, the present subject matter has been explained in detail with respect to a node migration event where services of a single node are to be migrated; however it will be understood that the principles can be extended to an event where services of multiple migrating nodes, exporting one or more same file systems 125, as well. In an example, to preserve locks in case of multiple migrating nodes scenario, like for single migrating node scenario, the cluster entity 150 may obtain node migration information regarding another migrating node. Further, in order to ensure that correct number of services is migrated, the migration event module 226 may merge the node migration information for the new migrating node and the previous migration node to form a common database file in the migration data 238. Since, the node migration information includes service names, the common services may be removed in the migration data 238 to correctly identify the number of services to be migrated.

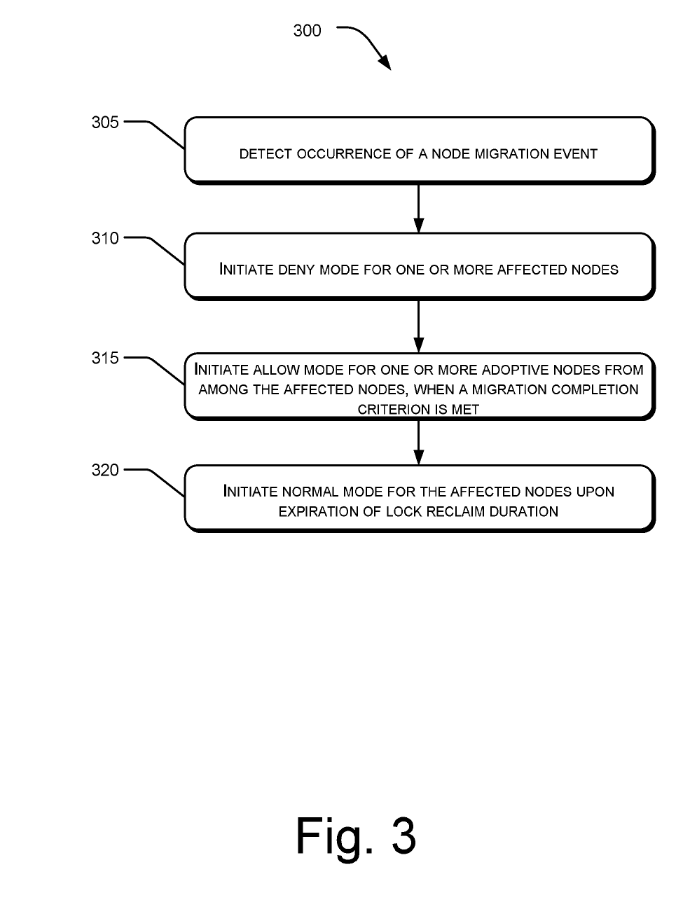

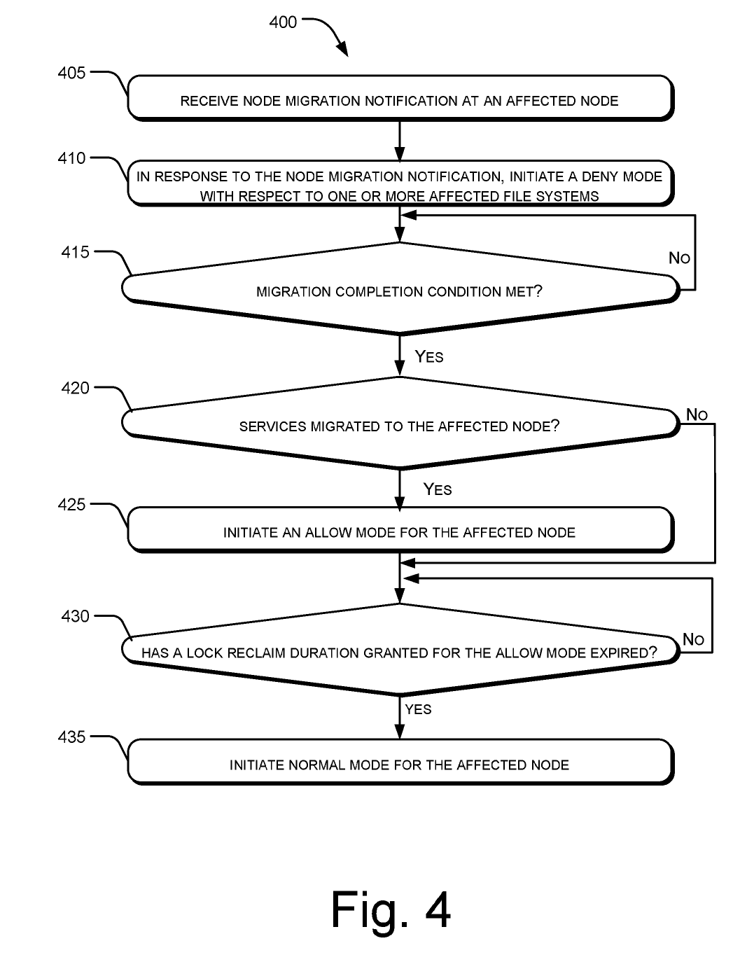

Methods for preserving file locks are explained with reference to description of FIG. 3 and FIG. 4, in accordance with an embodiment of the present subject matter.

The methods may be described in the general context of computer executable instructions embodied on a computer program product. The computer program product may include a computer readable medium. Generally, computer executable instructions can include routines, programs, codes, objects, components, data structures, procedures, modules, functions, etc., that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

The order in which the methods are described is not intended to be construed as a limitation, and any number of the described method blocks can be combined in any order to implement the method, or an alternative method. Additionally, individual method blocks may be deleted from the methods 300 and 400 without departing from the spirit and scope of the subject matter described herein.

Referring to FIG. 3, a method 300 illustrates a method, to preserve file locks in CFS environment, such as the CFS environment 100, according to an embodiment of the present subject matter.

At block 305, an occurrence of a node migration event in a cluster system, such as the cluster system 105 is detected. The node migration event is an event in which services of one or more nodes in a cluster may be migrated to another node in the cluster. For example, services of the node 120-1 may be migrated to the node 120-2 in the cluster system 105. In an implementation, the node migration event may be detected by the migration event module 226. The migration event module 226 may notify one or more affected nodes 120 regarding the node migration event. Upon receiving such a notification, the lock management modules 145 of the affected nodes 120 may determine the occurrence of the node migration event.

At block 310, in response to detection of the node migration event, a deny mode is initiated for one or more affected nodes. In an implementation, the lock management modules 145 of the affected nodes may not process any file lock requests in the deny mode.

At block 315, allow mode for one or more adoptive nodes from among the affected nodes is initiated. The other affected nodes may continue to be in the deny mode. In one implementation, the migration tracking modules 222 of the affected nodes may be configured to determine if the migration completion criterion is met. Further, the lock management modules 145 may initiate the allow mode for the corresponding affected nodes, when node migration criterion is met.

At block 320, a normal mode is initiated for the affected nodes, when a lock reclaim duration expires. In one implementation, the lock management modules 145 of the affected nodes may monitor the lock reclaim duration and lapse of the lock reclaim duration, may put the affected nodes on the normal mode.

Referring to FIG. 4, a method 400 illustrates a method performed by a computing device, such as the node 120, to preserve file locks, according to an embodiment of the present subject matter. Although, the method 400 has been explained with respect to a single node, it will be understood that the method 400 may be implemented in a plurality of nodes, such as nodes 120 in a cluster system, such as the previously mentioned cluster system 105.

At block 405, a node migration notification is received. The node migration notification may be received by an affected node. The node migration notification indicates the occurrence of a node migration event and may also include information, such as node IDs of one or more migrating nodes. For example, as explained in description of FIG. 3, the node migration notification may be provided by the cluster entity 150.

At block 410, in response to the node migration notification, a deny mode with reference to the affected file systems is activated for the affected node. In the deny mode, the file locking requests may be put in a wait state, where threads corresponding to the file locking requests may be invoked again, once the affected node switches from the deny mode to an allow mode or a normal mode. In an example, the lock management module 145 may put the file locking requests in the wait state.

At block 415, it is determined whether a migration completion criterion is met. The migration completion criterion, in an example, may be that the number of services to be migrated is less than or equal to a threshold, for example, zero. Additionally or alternately, another migration completion criterion can be expiration of a migration duration. In an example, the migration tracking module 222 may track the migration process to determine whether the migration completion criterion is met. If it is determined that the migration completion condition is not met (“No” branch from block 415), the method 400 branches back to block to 415.

However, if it is determined that the migration condition is met (“Yes” branch from block 415), the method 400 proceeds to block 420. At block 420, it is determined if services of the migrating node are transferred to the affected node. In other words, it may be determined if the affected node is an adoptive node or not. In an implementation, the migration tracking module 222 may determine whether the services are migrated to the affected node based on services migration data 238.

If it is determined that the services are migrated to the affected node (“Yes” branch from block 420), the method 400 proceeds to block 425. At block 425, an allow mode for the affected node, which is now the adoptive node, is initiated. In the allow mode, the adoptive node processes lock reclaim requests and may not process normal lock requests. In an example, the lock management module 145 may initiate the allow mode and process the lock reclaim requests.

On the other hand, if it is determined that the services are not migrated to the affected node (“No” branch from block 420), the method 400 may branch back to 430.

At block 430, it is determined whether lock reclaim duration granted for the allow mode has expired. In an example, the lock management module 145 may determine whether the lock reclaim duration has expired. If it is determined that the lock reclaim duration is not over (“No” branch from block 430), the method 400 branches back to block 430. However, if it is determined that the lock reclaim duration has expired (“Yes” branch from block 430), the method 400 proceeds to block 435.

At block 435, a normal mode is initiated for the affected node. In an example, the lock management module 145 may initiate the normal mode and may start processing normal lock requests. Thus, if the affected node is an adoptive node, the affected node may be put from the allow mode to the normal mode. Further, if the affected node is not an adoptive node, the affected node may be put from the deny mode to the normal mode

Although implementations of file lock preservation in computing devices have been described in language specific to structural features and/or methods, it is to be understood that the invention is not necessarily limited to the specific features or methods described. Rather, the specific features and methods are disclosed as various implementations for the file lock preservation in computing devices.

We claim:

1. A method to preserve file locks comprising:
detecting a node migration event in a cluster system (105), the node migration event occurring at a migrating node;
initiating a deny mode for an affected node in the cluster system (105) upon the detecting, the deny mode being initiated with respect to an affected file system exported by the affected node;
ascertaining whether a migration completion criterion is met; and
initiating an allow mode for an adoptive node when the migration completion criterion is met, the allow mode being initiated to process lock reclaim requests associated with the migrating node.

2. The method as claimed in claim 1, wherein the method further comprises:
ascertaining whether a lock reclaim duration has expired; and
initiating a normal mode for the affected node, wherein the affected node processes normal lock requests in the normal mode.

3. The method as claimed in claim 1, wherein the ascertaining comprises determining whether a number of services pending for migration is greater than a predetermined number.

4. The method as claimed in claim 1, wherein the ascertaining comprises determining whether a migration duration, provided for completion of migration of services from the migrating node to the adoptive node, has expired.

5. The method as claimed in claim 4, wherein the method further comprises dynamically setting a time duration for the migration duration, based on a number of the services to be migrated.

6. The method as claimed in claim 1, wherein the method further comprises, initiating, for the migrating node, the allow mode with respect to a migrating service and the deny mode with respect to other services running on the migrating node, the allow mode and the deny mode being initiated while migration of services from the migrating node to the adoptive node.

7. The method as claimed 1, wherein the method further comprises merging migration information, the migration information pertaining to the migrating node and another migrating node to provide migration data.

8. A computing device (120) to preserve file locks comprising:
a processor (202); and
a memory (206) coupled to the processor (202), the memory (206) comprising a lock management module (145) to,
initiate a deny mode with respect to an affected file system exported by the computing device (120), upon receiving a node migration notification;
ascertain whether a lock reclaim duration has expired; and
initiate a normal mode with respect to the affected file system, upon expiry of the lock reclaim duration.

9. The computing device (120) as claimed in claim 8, wherein the computing device (120) further comprises a migration tracking module (222) to ascertain whether services associated with a migrating node are migrated to the computing device (120), when a migration completion criterion is met.

10. The computing device (120) as claimed in claim 9, wherein the lock management module (145) initiates an allow mode with respect to the affected file system, upon migration of the services to the computing device (120), wherein the allow mode is initiated for the lock reclaim duration.

11. The computing device (120) as claimed in claim 10, wherein the lock management module (145):
determines whether a lock is granted to a blocking file lock request during the allow mode; and
unlocks the lock when the lock is granted to the blocking file lock request.

12. The computing device (120) as claimed in claim 8, wherein the lock management module (145) disables access to the affected file system in the deny mode.

13. A computer program product to preserve file locks comprising:
a computer readable storage medium having computer readable code embodied therewith, the computer readable program code comprising,
a computer usable program code to cause a processor (208) to detect a node migration event in a cluster system (105); and
a computer usable program code to cause the processor (208) to provide a node migration notification to an affected node in the cluster system (105), in response to the detection.

14. The computer program product computer as claimed in claim 13, wherein the computer readable storage medium includes computer usable program code to cause the processor (208) to obtain migration data (238) from an affected file system.

15. The computer program product computer as claimed in claim 13, wherein the computer readable storage medium includes computer usable program code to cause the processor (208) to initiate a deny mode for the affected node upon detection of the node migration event.
